(19) United States
(12) Patent Application Publication
(10) Pub. No.: US 2026/0317927 A1
(43) Pub. Date: Oct. 15, 2026

(54) METHOD FOR PRODUCING A CATALYST-COATED MEMBRANE FOR AN ELECTROCHEMICAL CELL, AND ELECTROLYTE CELL PRODUCED ACCORDINGLY

(71) Applicant: Siemens Energy Global GmbH & Co. KG, München (DE)

(72) Inventors: Konstantin Mierdel, Bamberg (DE); Christian Reller, Minden (DE); Luise Schilde, Erlangen (DE)

(21) Appl. No.: 19/485,313

(22) PCT Filed: May 15, 2024
(86) PCT No.: PCT/EP2024/063301

§ 371 Date: Nov. 18, 2025

(30) Foreign Application Priority Data
Jun. 2, 2023 (DE) 102023205168.0

(51) Int. Cl. C25B 13/08

(52) U.S. Cl. CPC C25B 13/08

(57) ABSTRACT

The invention relates to a method for producing a catalyst-coated membrane for an electrochemical cell. In the method, a powdery sulfonated fluorine-free polymer is first provided in a first step. In a second step of the method, the sulfonated fluorine-free polymer is dispersed in a water-free solvent to form plastisol. Then, in a third step, a catalyst material is mixed with the plastisol to form a catalyst paste. In a fourth step, the catalyst paste is then applied to a membrane substrate.

### BACKGROUND

The present invention relates to a method for producing a catalyst-coated membrane for an electrochemical cell, in particular a PEM electrolyte cell. Further, the invention relates to a corresponding electrolyte cell and an electrolyte plant having the electrolyte cell.

Due to its large potential for producing cost-efficient green hydrogen, the so-called PEM electrolysis (PEM for “polymer electrolyte membrane” or “proton exchange membrane”) is gaining more and more potential for industrial applications, but also as a storage medium or part of the same for energy storage. In the course of climate change, the element hydrogen and/or the possibility of producing H₂ from renewable energy via PEM or water electrolysis has long turned out as a key factor for the energy industry and neighboring sectors. Even if the largest part of the hydrogen is still produced by vapor reforming of methane today, aggressive investments, regulations and support measures surely bring about a foreseeable trend to regenerative hydrogen generation.

A particular promising method for obtaining hydrogen (H₂) is the electrolysis of water, in particular by using electrically renewable energy. Here, hydrogen can serve, among other things, as an energy storage by using it as a fuel, for example, in order to consolidate electrical energy supply in particular from renewable sources, such as wind power, photovoltaics or the like. But hydrogen can also be employed for other processes in which a fuel or a reducing agent is required. The hydrogen obtained during electrolysis can thus be used industrially, for example, or electrical energy can be obtained again using fuel cells in an electrochemical manner.

Separating water into its chemical components of hydrogen H₂ and oxygen O₂ can also be performed by means of suitable electrolyte cells. A particular important form is the described PEM electrolysis which in particular-compared to alkaline electrolysis approaches proves to be very load-dynamic through a less complex periphery and as better suited for the coupling of fluctuating current sources. In particular, high current densities and performances also at higher load gradients can be achieved via PEM electrolysis, wherein the high quality or purity of the hydrogen product also remains advantageously maintained in partial or overload operation, for example.

Hydrogen is already used in numerous industry and technology applications. Through the potential of being able to produce H₂ in a climate-neutral manner in large amounts and/or to store or to transport it “free of carbon” via hydrogen carriers such as ammonia, for example, different industrial sectors such as traffic, the chemistry or steel industry, are further shown completely new ways of supplying complete sectors with green energy or operating them in a climate-friendly manner. Also, hydrogen as a fuel or addition for fuels is already but also prospectively highly interesting due to its potential to cause no or less emissions.

In a PEM electrolyte cell, a membrane is provided which has, at opposite surfaces, a respective catalyst layer (catalyst coated membrane (CMM) or 3-layer membrane electrode assembly (MEA)). The catalyst layers are usually adjoined by respective gas diffusion layers, which are adjoined, in turn, by respective electrically conducting contact plates, called bipolar plates, which serve, among other things, electrical contacting. In one embodiment, these gas diffusion layers are, at the same time, also formed to be able to enable the required mass transport during the intended operation of the electrolyte cell. The gas diffusion layer provides the required “electrical conductivity” in order to electrically couple the contact plates and the catalyst layers to one another. Thus, the desired electrochemical reaction can be realized in the area of the catalyst layers.

Hydrogen is generated electrolytically from water as an educt. It is an electrochemical process in which water is separated into its chemical components, oxygen and hydrogen. The electrochemical cell reactions can be described and distinguished as follows:

| | |
|---|---|
| Anode electrode | 2H₂0 → 4H⁺ + 0₂ + 4e⁻ |
| Cathode electrode | 4H⁺ + 4e⁻ → 2H₂ |

During polymer-electrolyte-membrane electrolysis, the respective two partial reactions are spatially separated through an ion-conductive membrane which appropriately has to be provided with electrodes, in particular a cathodic catalyst and an anodic catalyst (CCM). Apart from material improvements, significant cost reductions can be achieved, among other things, through improvements of the manufacturing processes.

Since the production of PEM hydrogen electrolyzers (PEMWE) will increase significantly with regard to throughput and scale (scalability), even has to increase strongly in order to reach agreed climate goals, there is a compulsory need for technologies which enable to improve the throughput and the production capacity of so-called corresponding CCMs.

A CCM comprises a membrane which has a respective catalyst material on two surfaces facing away from one another. Here, very expensive and correspondingly very rare precious metals are employed as a catalyst material for many applications, in particular PEM water electrolysis.

Methods which are common today use a catalyst paste for generating the catalyst layers or electrodes for the anode and the cathode. The catalyst paste usually consists of the catalyst powder itself, an ionomer, possibly a polymeric binder and a solvent. Following application, the solvent is usually thermally removed. If the catalyst layer is deposited onto a thermally stable carrier film, it must be transferred to the membrane in a further process step under the influence of pressure and temperature (“decal method”). Thus, the electrode is to be fixed on the membrane in a sustainable manner and a good ionic contact between the catalyst materials and the membrane guaranteed. As an alternative to the decal method, the catalyst paste can also be directly applied to the membrane (“direct membrane coating”).

An industrially already established technology for producing hydrogen is polymer electrolyte membrane water electrolysis (PEMWE), whose name is derived from the electrolyte, the polymer membrane. According to the current state of the art, both the membrane and components of the electrodes consist of polyfluorosulfonic acid (PFSA) ionomers. However, fluoropolymers are suspected to be dangerous to health as they cannot be degraded in the environment and in the human body due to their outstanding chemical resistance. As a reaction to the findings, the European Chemicals Agency (ECHA) has recently published the proposal for a Europe-wide ban of polyfluoroalkyl substances (PFAS), of which the PFSA polymers are a part. The threatened ban, but also the announcement of large polymer producers to independently stop production of all fluorinated substances soon, highlights the urgent need for the development of long-term stable, marketable fluorine-free alternatives to enable the production of hydrogen through PEMWE electrolysis with an environmentally friendly alternative in the future as well.

### SUMMARY

Therefore, the invention is based on the object of providing a significantly improved production approach for the production of catalyst-coated membranes (CCMs) and corresponding PEM electrolyte cells and/or cell stacks, which is to be preferred in particular from an environmental perspective.

The object is achieved according to the invention through a method for producing a catalyst-coated membrane for an electrochemical cell, providing a powdery sulfonated fluorine-free polymer, dispersing the sulfonated fluorine-free polymer in a water-free solvent to form a plastisol, mixing a catalyst material with the plastisol to form a catalyst paste, and applying the catalyst paste to a membrane substrate.

The invention already starts from the understanding that the formulation of the catalyst paste is of vital importance in the production of a catalyst-coated membrane. It has a great influence on the formation and long-term stabile binding of the catalyst layer to the membrane substrate. It has been shown that references to known formulation and application methods of catalyst pastes from PFSA technology can be transferred to the development and binding of fluorine-free polymers in coating methods only to a very limited amount.

Thus, technical coating methods which are based on water/alcohol ionomer dispersions are also proposed for fluorine-free polymers. On the one hand, these methods are hardly suitable for a direct coating since the dispersing agent of water or alcohols leads to a strong swelling behavior of the membrane substrate and thus the dimension stability of the membrane or of the CCM is very adversely affected. Catalyst inks on the basis of water/alcohol ionomer dispersions further have a very low viscosity and tend to unmix after a few minutes only. Through the addition of additives such as thickeners, such as methylethylcellulose, for example, viscosity is often increased, but such excipients must also be thermally decomposed again after applying the catalyst paste or burned out at temperatures over 300° C. Thus, on the other hand, the membrane would be decomposed or the catalyst material structurally damaged. In order to avoid this, the decal method described above is often used in the state of the art. The high number of process steps disadvantageously results in long turnaround times and higher process costs compared to a membrane direct application.

Meanwhile, apart from the advantages or the future requirements, it has been shown with regard to the environmental aspects that fluorine-free ionomers bring about further technical advantages compared to the application of PFSA, such as a higher process temperature and a lower gas transfer through the membrane.

An aspect of the present invention relates to a method for producing a catalyst-coated membrane for an electrochemical cell, in particular an electrolyte cell. In contrast to the membrane with a membrane substrate as such, a catalyst-coated membrane (CCM) comprises at least one porous electrode which is realized through the application and binding of a catalytically active porous layer. During paste formulation, the choice of the solvent in combination with the selection of fluorine-free polymers is of great importance. In contrast to the known coating methods, the invention proposes the application of a water-free solvent for the catalyst paste for the production of a CCM.

In contrast to the previous work for processing fluorine-free ionomers by means of water/alcohol mixtures on the basis of methanol, ethanol or isopropanol, the electrode compositions described here create a more stable “interlayer”, i.e. an intermediate layer or binding layer between the membrane substrate and the electrode which leads to an increased electrochemical stability and thus to longer service lives when being applied in water electrolysis. Through a largely conspecific material adaption through the choice of a corresponding fluorine-free membrane substrate comprising a sulfonated fluorine-free polymer to the corresponding fluorine-free polymer in the catalyst paste, the formation of this adhesion promoter layer as an “interlayer” is caused in combination with the water-free solvent.

The method includes providing a solid or powdery, i.e. preferably non-dissolved or contained in solution, sulfonated fluorine-free polymer.

The method also includes dispersing this starting material or sulfonated fluorine-free polymer into a water-free solvent, in particular a high boiling, polar solvent such as 2-pyrrolidone or γ-butyrolactam, for example, to form a plastisol.

The method further includes intimately mixing or blending an in particular metallic catalyst starting material, for example in solid form or in powder form, with the plastisol to form a catalyst paste as an application paste, and subsequently, preferably directly applying (direct membrane coating) of the catalyst paste to a corresponding membrane substrate. A catalyst paste described before can be very advantageously employed in a direct membrane coating method. This is the significantly larger application potential compared to a decal method.

Thus, the present invention advantageously enables low-cost and easily scalable manufacturing of large catalyst-coated membranes for PEM water electrolysis.

In particular the application of the catalysts, whether as a so-called HER (“hydrogen evolution reaction”) for the hydrogen development reaction described above on the cathode, or as OER (“oxygen evolution reaction”) for an anode-side oxygen development reaction, can be advantageously significantly improved through the advantages of the present invention so that an employment of fluorine-free catalyst-coated membranes (CCMs) at HER and OER in an electrolysis cell becomes possible.

Furthermore, the invention discovers manufacturing of fluorine-free membranes (CCMs) coated with catalyst material at an industrial scale in a roll-to-roll application technique and thus advantageously enables faster throughput times of corresponding components of electrolyzers. The presented method furthermore advantageously enables to significantly improve both the ionic and the mechanic binding of the catalyst material to the membrane substrate for fluorine-free membrane electrode assemblies (MEAs). Further, the advantageously high material compatibility and a very good paste stability of the catalyst paste and also an improved sedimentation behavior of this paste formulation and the application are to be highlighted. Also, from a technical and economical view, complex pressing methods and post-processing processes are eliminated.

In one embodiment, the water-free solvent, in particular a polar, high boiling solvent, is selected from dimethyl sulfoxide, N,N-dimethylformamide, N,N-diethylformamide, 2-pyrrolidone or γ-butyrolactam, N-methyl-2-pyrrolidone, N-ethyl-2-pyrrolidone. It has been shown that through the choice of one of the solvents of the group of water-free solvents mentioned above in a particular manner in cooperation with the sulfonated fluorine-free polymer, a formation of an intermediate layer (“interlayer”) as a functional layer for a good and long-term stable adhesion of the catalyst to the membrane substrate is facilitated, i.e. a material connection is created. This is achieved through a targeted and, compared to water-based solvents, increased dissolution of the surface of the membrane substrate. Thus, especially the electrochemical stability of the catalyst-coated membrane and a high long-term stability upon application in an electrochemical cell are supported.

In another embodiment, the water-free solvent is a mixture of N-methyl-2-pyrrolidone and a percentage selected from N-ethyl-2-pyrrolidone, γ-butyrolactone or diethylene glycol monoethyl ether. Through application of a mixture of solvents, a further increased adaptation possibility during the production of the catalyst paste is given so that depending on the coating system of the catalyst layer a sufficiently high dissolution of on the surface of the membrane substrate is effected and an intimate material connection in the region of the intermediate layer.

In exemplary embodiments, the catalyst material comprises iridium Ir, which is in particular provided as solid or powdery so-called “Iridium Black”, for the anode-side coating of the membrane substrate. According to this design, a particularly efficient OER catalyst for a catalyst-coated membrane in a membrane arrangement or CCM is furthermore provided. Alternatively or additionally, the anode-side catalyst material can contain IrOOH, IrO2, IrRuO2 or TiO2-, NbO2- or SnO2-supported variants of the previously mentioned catalysts or corresponding material systems.

In one design for the cathode, the catalyst material comprises platinum, in particular in the shape of solid or powdery so-called “Platinum Black” for the HER catalyst. Alternatively or additionally, palladium, ruthenium or coal-supported variants/mixtures of the previously named catalysts can be contained.

In one embodiment, the material of the membrane substrate is composed of a fluorine-free sulfonated polymer, wherein the sulfonated fluorine-free polymer of the catalyst paste is adapted thereto.

In this design, the sulfonated fluorine-free polymer is in a targeted manner adapted to a material of the membrane substrate to be of a similar type or similar thereto. According to this design, the binding of the catalyst layers to the membrane substrate is significantly improved. In other words, the catalyst paste with the water-free solvent can also function as a very effective binder or adhesive for binding and inherently facilitates the formation of an intermediate layer for adhesion promotion. Thus, a very stable interlayer is formed by partially dissolving the material of the membrane substate through the application method and thus causing and optimizing a permanent and intimate binding in the boundary region to the catalyst layer.

The term “of a similar type” or similar should mean, for example, that both mentioned materials are at least fluorine-free polymers, but not necessarily concern the same type of polymer. It is also possible that both polymers are sulfonated. In this context, the one polymer can be a hydrocarbon-based polymer, for example.

In one embodiment, the method leads hardly, not at all or nearly not at all to disadvantageous sedimentation and/or unmixing effects of the sulfonated fluorine-free polymer and/or of the catalyst material in the catalyst paste, for example.

In one embodiment, the sulfonated fluorine-free polymer is provided by a fluorine-free hydrocarbon compound which has a cation-conducting group. This can be realized, for example, by means of an aromatic hydrocarbon compound which has a cation-conducting group.

In one embodiment, a polyaromatic ionomer having a sulfonated side group as a cation-conducting group is provided as a sulfonated fluorine-free polymer.

In one embodiment, the polyaromatic ionomer is selected from the group of sulfonated polyether ketones (sPEEK), sulfonated polyphenylenes (sPPX) and sulfonated polyimides (sPI). These can also be referred to as fluorine-free “hydrocarbons” which are here preferably used as fluorine-free polymer classes for the catalyst paste and for the membrane substrate in contrast to the previously common and still widely used perfluorinated ionomers for PEM electrolysis.

In principle, the most different fluorine-free polymers can be chosen for functionalization to the ionomer for providing a catalyst-coated membrane (CCM) or a membrane electrode assembly (MEA). For PEM water electrolysis, the polyaromatic ionomers are of particular interest due to the high requirements on the chemical, thermal and mechanical properties. The largest groups of hydrocarbons for PEM electrolysis, which are preferred here, are poly(arylene ether), polyphenylenes and polyimides. All have in common that they have a low gas crossover. The largest group are the poly(arylene ether) based hydrocarbons, of which sulfonated polyether ether ketones (sPEEK) are a part. The biggest advantage is the good availability and the low costs compared to PFSA. It also has a high mechanical strength and a high thermal stability. A further group are sulfonated polyphenylenes (sPPX) which have similar characteristics. Its large advantage is the high stability of the backbone against chemical degradation. Further, there are sulfonated polyimides (sPI) which also have a high thermal stability, a high mechanical strength and a good film formation. The biggest challenge with sPI is the hydrolysis of the imide rings in the hydrated condition at operating temperatures relevant for PEMWE. The same applies to hydrocarbons with an aliphatic main chain which have low oxidation resistance.

In one embodiment, the catalyst paste is intimately mixed to form a paste mixture in the method, wherein a high solids content of the catalyst material and sulfonated fluorine-free polymer of 35 wt % to 60 wt %, in particular of 45 wt % to 55 wt %, is set in the paste mixture.

In tendency, comparably higher solids contents compared to PFSA based systems have proven to be advantageous in order to produce a fluorine-free catalyst-coated membrane (CCM) with the demanded properties for the application in a PEM electrolyte cell. This can be adjusted and adapted to the respectively chosen application-specific paste formulation which comprises the solvent, the fluorine-free sulfonated fluoropolymer and the catalyst material system. Therefore, when mixing the catalyst paste, a solvent content (LMA) to solids content (FKA) of 40/60, 45/55 or 50/50, for example, in weight content is to be preferably set depending on the requirement.

Paste formulation or paste manufacturing is divided into the following steps: producing the ionomer dispersion and the subsequent mixing process with catalyst material in particulate form. Special consideration is to be given to the interactions between the components as these significantly determine the material properties of the catalyst paste. The rheological properties play a decisive role in the coating step following paste formulation by influencing, for example, the electrode structure, thickness and weight. Preferably, a balance between the disadvantages of low-viscosity pastes (thickness variation, unmixing) and high-viscous pastes (clogging of the coating tool, mixing process problems) is pursued. In general, for the application of the catalyst paste to the membrane substrate with fluorine-free CCMs, catalyst pastes with higher viscosity are to be preferred in order to give preference to a good electrode structure of the CCS and a particularly intimate, even and at the same time long-term stable binding of catalyst material on the membrane substrate and the formation of a stable intermediate layer, the interlayer, here.

In one embodiment, a direct application of the catalyst paste to the membrane substrate, which is performed by means of a blade application and optionally with the help of a vacuum plate which is adapted to hold the membrane substrate, occurs. According to a design with a vacuum plate, the method according to the invention is then rather performed in a laboratory or at a small industrial scale, e.g. for a test or for industrial small series of catalyst-coated membranes.

In one embodiment, the direct application of the catalyst paste to the membrane substrate is performed by means of a roll-to-roll application method, in particular by using a furnace for a heat treatment during paste application for driving out the solvent.

According to this design, the production method itself is subject to hardly any limitation, for example with regard to the coating width, and can thus be scaled to larger and larger throughputs or manufacturing batches, wherein manufacturing capacities for electrolyte cells can be significantly increased as a whole. In particular, one is no longer bound to percentage limitations of the state of the art due to these advantages.

In one embodiment, there is an appropriate heat treatment via a furnace during the direct application of the catalyst paste to the membrane substrate, for example a multi-chamber furnace in the case of the double-sided coating of the membrane substrate, for driving out the solvent and/or a binder optionally introduced into the catalyst paste after the application of the catalyst paste.

In one embodiment, the application of the catalyst paste to the membrane substrate further is via a slot nozzle or slot nozzle coating, in particular via so-called wide slot nozzles, i.e. by means of roll-to-roll application, for example. This design advantageously offers the possibility to control the sought wet film layer thickness of the application through the measured mass current and a predetermined substrate speed.

In one embodiment, on the other hand, the application of the catalyst paste to the membrane substrate is via an application, dosing or screen roll. Via this design, the coating can advantageously be performed in a simple and self-dosing manner as well as intermittently, i.e. interrupted if required.

In one embodiment, the application of the catalyst paste to the membrane substate is double-sided, in particular with different catalyst materials to the opposite sides or surfaces of the membrane substrate. Due to the described requirements of the electrolysis reaction at the cathode and at the anode, there is usually a need to perform different catalyst coatings on the cathode and the anode.

In one embodiment, application of the catalyst paste is only to one side of the membrane substrate or of the membrane, and on the side facing away from this first side—functional membrane surface—a so-called decal method is used for the coating, for example. According to this design, the invention can advantageously also be exploited for “one-sided” coating plants if required. But the greater advantages for an industrial application result from a direct coating for producing fluorine-free coated membranes with a corresponding catalyst layer on the anode side and on the cathode side, as described above.

In one embodiment, a drying step is performed after applying the catalyst paste to the membrane substrate, in which drying, curing and, if required, thermal post-processing of the catalyst material on the coated membrane substrate is caused.

Typically, drying in a circulating air dryer at a drying temperature of 60° to 80° C., for example, alternatively up to 100° C., is performed.

Drying in the drying step is an important process step of MEA manufacturing according to the method described here as it influences the evaporation rate of the solvent and the volume reduction and thus contributes significantly to the formation of the electrode structure. It is evaporation-dominated for catalyst pastes with a high solids content.

The drying process can be divided into the three phases of liquid, gel-like and solid. First, the paste film shrinks up to its final electrode thickness before the pores are emptied through the evaporating solvent. For a high drying temperature, it generally applies that a high porosity is formed and the ionomer migrates on the upper free surface. However, this leads to a lower adhesive strength of the electrode to the membrane, which can lead to delamination. Therefore, moderate drying temperatures are to be preferred in particular for the fluorine-free CCM according to the invention, so that 70° C. to 80° C. are preferred. The drying step can also comprise an adapted thermal post-processing of the laminated structure, the so-called “curing”. This curing through well-dosed heat input is preferably monitored and applied iteratively, if required, until the indicated structural properties of the electrode applied to the membrane and the CCM are achieved.

In one embodiment, an ionomer content of 6 wt % to 15 wt %, in particular of 9 wt % to 12.5 wt % is set on the anode side and/or cathode side in the layer applied to the membrane substrate and having the catalyst material.

The ionomer content can be set during paste formulation via the weight content of the solids content of added powdery sulfonated fluoropolymer in the catalyst paste, i.e. in the dispersion or paste-like mixture of the water-free solvent, the catalyst material and the fluorine-free polymer, so that a correspondingly preferred ionomer content results after the drying step. It has been shown that ionomer contents with the preferred weight content mentioned above are particularly appropriate for the functioning of the fluorine-free CCM and the provision of the required transport characteristics. Sufficient porosity is required for the water and gas transport. It is typically about 60%. In case of a poor gas transport, an increased gas pressure is created, which can lead to a gas blowby through the membrane. Therefore, the gas crossover is connected to the ionomer content. Therefore, a favorable working point for the ionomer content for the formulation of the catalyst paste and the dried CCM is a compromise between a small pore volume and mass transport losses, at a comparably high ionomer content and poor proton conductivity and ionic ohmic voltage losses at a rather low ionomer content.

The ionomer content depends on the components and the respective use in the anode or cathode and can also adopt larger values up to 30 wt % compared to the usually preferred somewhat lower ionomer contents. Last, but not least, the final microstructure is influenced by the type of the coating and drying process.

A further aspect of the present invention relates to a catalyst-coated PEM membrane or membrane arrangement which is produced or can be produced by the described method.

A still further aspect of the present invention relates to an electrolyte cell which uses a variant of the CCMs described before, for example with double- or one-sided electrodes.

A further advantageous aspect of the invention is formed by a plurality of such electrolyte cells which are stacked and electrically connected in series. These form a cell stack or an electrolyte stack which are scalable for large electrolyte performances.

Therefore, an electrolyte plant which has such a cell stack is proposed in a particularly preferred design of the invention.

Thus, the achievements of the present invention are manifested not only in the small or minimum product unit, such as the membrane or the CCM, but through the scaling effect significantly also on the electrolyte cell and a cell stack, electrolyzer or electrolyte system correspondingly having the electrolyte cell, which concerns further aspects of the present invention. Thus, with regard to the environment, a production approach for future fluorine-free CCMs for water electrolysis and their application at an industrial scale is possible.

In particular, the present invention relates to PEM electrolyzers and furthermore complete electrolyte or power-to-X power plants which have a presently described electrolyte plant.

Thus, designs, features and/or advantages which refer to the method here, further concern the produced product itself or the membrane arrangement as well as the electrolyte cell, the cell stack, the electrolyte plant and/or a complete power-to-X power plant, and vice versa.

As used herein, the term “and/or” or “or” when employed in a series of two or more elements means that each of the elements listed may be used individually, or any combination of two or more of the elements listed may be used.

### BRIEF DESCRIPTION OF THE DRAWINGS

Exemplary embodiments of the invention are explained in detail with reference to a drawing. Herein, the following is shown in a schematic and highly simplified manner:

FIG. 1 shows, in a representation, the functioning of an electrolyte cell for water electrolysis, in particular a PEM electrolyte cell, with a catalyst-coated membrane used therein;

FIG. 2 implies general method steps according to the invention by means of a schematic flow diagram;

FIG. 3 shows an application method for coating a membrane substrate for producing a catalyst-coated membrane;

FIG. 4 shows a variant of the application method shown in FIG. 3 for coating a membrane substrate;

FIG. 5 shows an alternative application method for coating a membrane substrate;

FIG. 6 shows, as an example, by means of a polarization curve, an electrochemical characterization of a fluorine-free catalyst-coated membrane (CCM) which is produced by means of direct membrane application of the catalyst material to a membrane substrate;

FIG. 7 shows, as an example, the long-term stability of two different fluorine-free CCMs at a predetermined current density.

FIG. 8 shows, for a CCM in a simplified representation, the intermediate layer (“interlayer”) which is formed through the application method between the membrane substrate and the catalyst layer.

In the exemplary embodiments and FIGs, identical or identically acting elements can each be provided with the same reference numerals. The elements depicted and their sizes relative to one another are not to be regarded as true to scale; rather, individual elements may be depicted in exaggerated thickness or large dimensions for better visualization and/or for better understanding.

### DETAILED DESCRIPTION

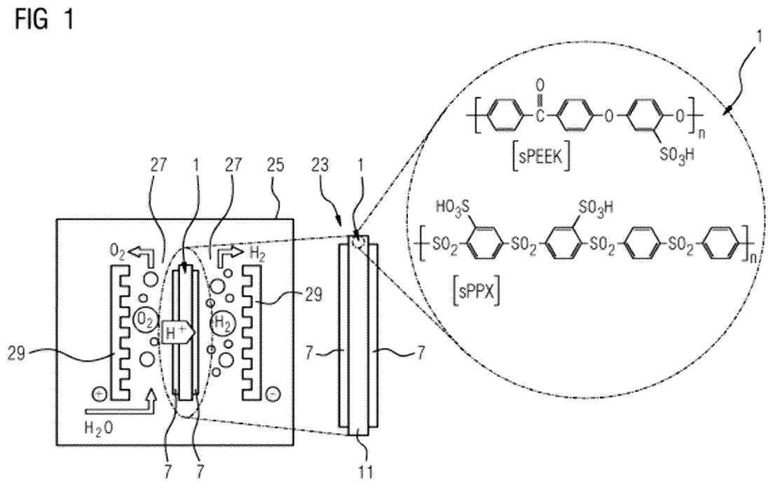

In FIG. 1, an electrolyte cell 25, in particular a PEM electrolyte cell for water electrolysis, is represented in the left part of the picture. An important functional element of such a polymer-electrolyte-membrane-electrolyte cell 25 is usually formed by a catalyst-coated membrane 23 which is shortly also referred to as CCM. Such a membrane 23 or CCM is shown in more detail in a representation to the right of the electrolyte cell 25 in FIG. 1.

The catalyst-coated membrane 25 has a membrane substrate 11 which is coated on both sides with a catalyst material 7. For this, the membrane substrate 11 is usually coated both on the anode side and the cathode side on two opposite surfaces facing away from one another with a layer of a respective catalyst material 7. In the region of the layer formed by the respective catalyst material 7, the respective cell reaction of the electrolysis takes place. In doing so, during the operation as intended, electrodes are discharged via the respective catalyst material 7 and a carrier or channel structure which can be formed by or provide the gas diffusion layer 27 to the contact or bipolar plates 29, compare the electrolyte cell 25 in the left part of the representation.

It can further be recognized that fully desalinated educt water H2O is usually provided on the anode side and supplied to the PEM electrolyte cell 25. The educt water H2O is decomposed into oxygen O2 and hydrogen H2 by way of the electrolyte process. In doing so, as electrolyte products, oxygen O2 is formed at the anode and hydrogen H2 is formed at the cathode as product gases and obtained separately and discharged from the PEM electrolyte cell 25.

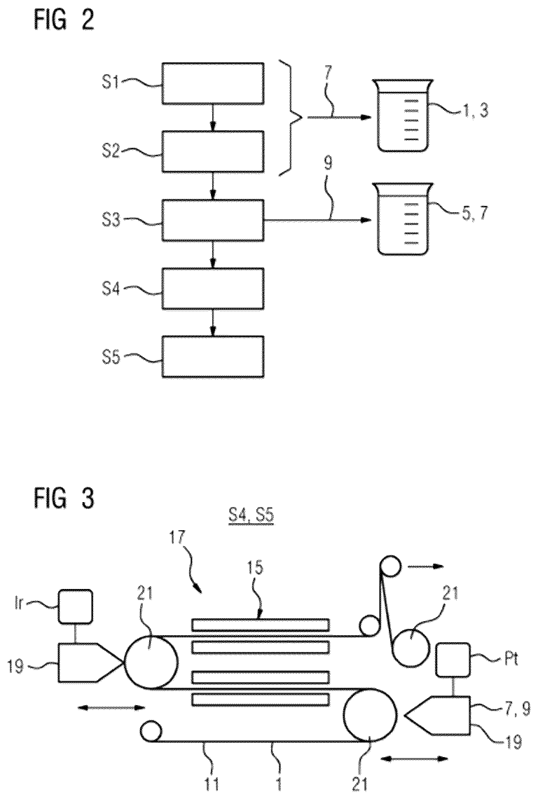

The catalyst-coated membrane 23 comprises a membrane substrate 11 of a membrane material which, when producing a coated membrane 23, is coated with one of a paste-like, viscous catalyst paste 9 as a coating material. The catalyst paste contains the catalyst material 7. The membrane substrate 11 is fluorine-free and contains, as an ionomer, a sulfonated hydrocarbon polymer for proton conduction, a so-called hydrocarbon or is formed therefrom. In doing so, materials of the sulfonated polyaromatics are selected as a fluorine-free polymer for the membrane substrate. For example, as illustrated in FIG. 2, a so-called sPEEK or sPPX can be used for the membrane substrate 11 or the membrane substrate 11 can be formed therefrom. The largest group are the poly(arylene ether) based hydrocarbons, of which sulfonated polyether ether ketones, sPEEK, are a part. A further group are sulfonated polyphenylenes (sPPX) which have similar characteristics. Its large advantage is the high stability against chemical degradation.

Ionomers are polymers with ionic groups which give them the characteristic property of proton conductivity. The ionic groups are sulfonic acid groups (—SO3H) in the case of PEM water electrolysis. They can be present randomly distributed or fixedly arranged. In PEM water electrolysis, ionomers are primarily employed as a membrane material in the membrane substrate 11 and in the electrode applied to the membrane substrate 11, i.e. inserted into the layer having the catalyst material 7, due to their proton conductivity and simultaneous electric insulation capacity, so that here, a material adaption is made in particular for the fluorine-free catalyst-coated membrane 23.

Providing the coating material is explained in more detail by means of FIG. 2. FIG. 2 implies, by means of a schematic flow diagram only, method steps according to the invention in order to in particular show the paste formulation for the catalyst paste 9. The method according to the invention is a process for producing a catalyst-coated membrane 23 for an electrochemical cell, in this case an electrolyte cell 25 for water electrolysis.

First, the method comprises in step S1 the provision of a fluorine-free ionomer as a starting material in solid shape, i.e. this starting material preferably is not in solution, but in the shape of a fine-grained powder. A powdery sulfonated polymer 1 from the group of the hydrocarbons is selected as an ionomer, in the present case a sulfonated polyether ether ketone having sPEEK, for example.

For the provision of the powdery fluorine-free polymer 1 in step S1, commercially available packaged dispersions which already contain the respective fluorine-free polymer to be applied can be used, for example. These can be transferred into the desired powder before, for example through a spray drying step, for obtaining or separating the powdery fluorine-free polymers from the dispersion. Such a spray or atomization drying is a process engineering method for drying solutions or suspensions, for example. In doing so, the material to be dried is introduced into a hot gas flow or evaporated therein, which dries it into a fine powder within short time.

The drying method can be performed with the following parameters or provisos, for example: injection temperature 120° C., injection pressure of 10 bar, nozzle dimension 0.5 mm, jacket or wall temperature of 250° C., a gas temperature of 380° C. and/or at a gas flow of about 50 l/min. Alternatively, for example, vacuum spray drying with a single- or two-component nozzle can be performed with the following parameters: a pressure of 100 mbar, for example, a nozzle bore of about 0.3 mm, an injection temperature of 130° C., a jacket temperature of 200° C. and a nozzle pressure of 10 bar, for example.

The method further comprises, in step S2, dispersing, introducing or processing the fluorine-free polymer 1 in a water-free solvent 3 to form a plastisol 5. In this case, the term “plastisol” is to generally designate a dispersion or a heterogeneous mixture.

| | Ionomer | | |
|---|---|---|---|
| | content in | Possible | |
| | the stock | viscosity | Boiling |
| Solvent | solution | range | point |
| dimethyl sulfoxide | 7-16 wt % | 100 to 500 mPas | 189 °C |
| N,N- | 7-18 wt % | 100 to 500 mPas | 153 °C |
| dimethylformamide | | | |
| N,N-diethylformamide | 7-18 wt % | 100 to 500 mPas | 176 °C-178 °C |
| 2-pyrrolidone / | 7-20 wt % | 100 to 500 mPas | 245 °C |
| γ-butyrolactam | | | |
| N-methyl-2- | 7-20 wt % | 100 to 500 mPas | 203 °C |
| pyrrolidone | | | |
| N-ethyl-2-pyrrolidone | 5-15 wt % | 100 to 500 mPas | 212.5 °C |

For example, the water-free solvents 3 or solvent combinations indicated in the table overview shown above can be used with the further indicated specifications, in particular for the possible ionomer content. These indicated value ranges for the ionomer contents and paste viscosities are generally preferred windows for the formulation and can be adapted to the respective requirement. For example, binary mixtures of N-methyl-2-pyrrolidone and a percentage selected from N-ethyl-2-pyrrolidone, γ-butyrolactone or diethylene glycol monoethyl ether have proven successful as mixing solutions of two of the named solvents 3. Depending on the application case and material composition of the catalyst paste 9 for a respective membrane substrate 11, larger viscosities than 500 mPas are possible as well, for example up to 1000 mPas.

The method according to the invention further comprises, in a method step S3, the intimate and homogeneous mixing of a catalyst material 7 with the plastisol 5. From this method step S3, a paste-like, generally viscous or highly viscous coating material is obtained, which forms the catalyst paste 9. The paste mixture catalyst paste 9 is set to have a high solids content in total of catalyst material 7 and sulfonated fluorine-free polymer 1 of 35 wt % to 60 wt %, in particular of 45 wt % to 55 wt %.

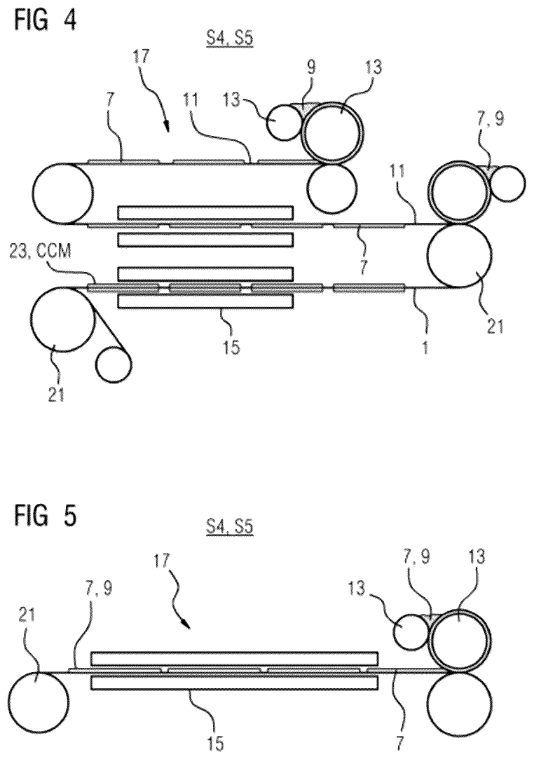

Furthermore, the method comprises in step S4 the direct application of the catalyst paste 9 to a membrane substrate 11 of a material of the same type, e.g. a corresponding fluorine-free polymer 1 such as sPEEK. When applying the catalyst paste 9 obtained in method step S3 to the membrane substrate 11, a direct coating method is applied. Thus, the present invention enables in a particularly advantageous manner a cost-efficient and scalable manufacturing of a large-format, fluorine-free catalyst-coated membrane 23. Such a catalyst-coated membrane (CCM) can be applied for PEM water electrolysis in a particularly environmentally friendly manner. Due to the performed paste formulation and the obtained and adaptable viscosity properties (rheology), the fluorine-free catalyst pastes 9 described here enable and facilitate the use of standardized R2R application methods (roll-to-roll) at an industrial scale for direct membrane coating and possibly also further application methods, as explained further below in FIG. 3 and FIG. 4. After applying the catalyst paste 9 to the membrane substrate 11, a drying step S4 follows. There, drying, curing and optionally multi-step thermal post-processing of the catalyst-coated membrane 23 occurs. In this way, a good surface structure of the catalytically active porous layer and long-term stable and even binding to the membrane substrate 11 is achieved.

Depending on the application method, an adequate viscosity range can be advantageously set via the solvent combination. Furthermore, the achievable paste viscosity is still largely determined by the water-free solvent 3 or solids content in the catalyst paste and the solids ratio. The solids ratio indicates the ratio of the ionomer content to the content of the catalyst material in the catalyst paste 9.

10 to 20 wt %, in particular 9 wt %, of plastisol of the combination of Pemion™ as a fluorine-free ionomer and 2-pyrrolidone (500 mPas) for the coating with a wet film thickness of about 30 to 70 μm, in particular 50 μm, and the use of a reverse roll or application roll method have proven to be particularly advantageous. With the fluorine-free ionomer TS00X and the solvent content of N-methyl-2-pyrrolidone (NMP) of 5 to 12 wt %, in particular 7 wt %, similarly good results can be achieved.

It is in particular an object to provide a catalyst paste 9 which enables an efficient covering of the catalyst particles with fluorine-free ionomer and a highly stable paste for applications at an industrial scale, but in particular show no or few unmixing effects or sedimentation. This has proved successful with the present described provisos.

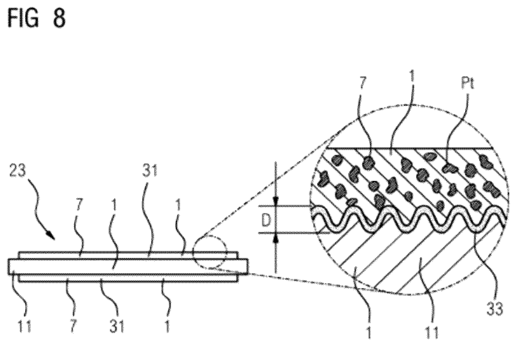

Further important aspects are the film formation in the drying step S5 of the catalyst paste 9, such as through a furnace 15 shown in FIG. 3 to FIG. 5 and applied in the course with corresponding roll-to-roll methods, for example. In doing so, it is still significant that the layer is dried as quickly as possible and good adhesive properties of the application to the (membrane) substrate are set so that the formation of the intermediate layer 33 is facilitated. This is explained further below by means of FIG. 8.

With the proposed method, in particular a characteristic intermediate layer 33 (see FIG. 8) as an important functional layer (“interlayer”) is achieved not by reaching the glass transition temperature of the membrane substrate under increased pressure, but instead, this is done in the present case through a targeted and sufficient dissolution of the membrane substrate 11 in the boundary region to the applied layer with the catalyst material 7. In other words, the fluorine-free ionomer 1 of the class of the hydrocarbons is chosen such that it appropriately has the same material as a material of the membrane substrate 11 itself. Due to this adaptation through the application of the catalyst paste 9 the function of a binder or adhesive for the catalyst material 7 is advantageously achieved at the same time. In doing so, the advantageous effect of the selection of a water-free solvent 3 for the catalyst paste 9 has shown to facilitate this dissolution process in the boundary layer and the formation of the intermediate layer.

A possible exemplary embodiment for producing a described plastisol 5 as a stock solution comprises, for example, the provision of 5 g of a fluorine-free polymer, for example Pemion™ in powder form, which is stirred into 30 g of 2-pyrrolidone solution. Complete dissolution is after several hours.

For the production of a catalyst paste 9 for cathode electrodes for catalysis of the HER reaction, 10 g Pt-black can be provided, for example, and blended with 10 g of a 10 to 20 percent fluorine-free hydrocarbon plastisol stock solution and then intimately mixed with ZrO2 milling balls in a paste mixer. A setting or an agglomeration of the particle is not observed, so that a HER catalyst is formed on the cathode side.

For the production of a catalyst paste 9 for anode electrodes using 10 g Ir-black with 10 g together with 10 g of a comparable fluorine-free hydrocarbon plastisol stock solution, good results can be achieved correspondingly.

As alternatives to the mentioned HER catalyst, palladium-, ruthenium- or carbon-supported variants and mixtures of the ones mentioned before can also be used as catalyst materials in the catalyst paste 9 for the cathode. As alternative designs for the OER catalyst, IrOOH, IrO2, IrRuO2, or TiO2-, NbO2- or SnO2-supported variants of the catalysts mentioned before can optionally be used as catalyst materials in the corresponding catalyst paste 9 for the anode.

The coating of the membrane substrate 11 having a similar or identical fluorine-free hydrocarbon with the catalyst paste 9 containing the catalyst material 7 finally is with a direct application according to method step S4. Direct application is applied without any transfer, transmission or pressing steps. This advantageously applicable coating method is also referred to as direct membrane deposition (DMD).

For this, a simple blade application can be performed, for example, wherein the catalyst paste 9 is distributed and/or applied to the membrane substrate 11 held and/or moved through a vacuum plate, for example—not explicitly characterized in the present Figures—with a blade. This design is particularly appropriate for assay lots or laboratory samples in rather small quantities. With or without a short drying time, the membrane 23 (CCM) catalyst-coated on one side with the catalyst paste 9 can be dried in a furnace 15 (see below) between 5° and 100° C., for example. Subsequently, the backside of this completely coated half membrane can be coated in an analogous manner until, for example, a final drying or temperature control is performed, preferably at temperatures clearly above 100° C.

In FIG. 3, a preferred application method for coating a membrane substrate 11 for producing a catalyst-coated membrane 23 is represented. FIG. 3 shows an only schematic side or sectional view of a coating means 17 which uses the general roll-to-roll principle and has corresponding rolls 21 for fixating and conveying the membrane substrate 11. Specifically, the application of the catalyst paste 9 preferably is via so-called wide slot nozzles 19 which are arranged and positioned on both sides of the coating means 17. The wide slot nozzle 19 represented on the right is formed to coat a first active side of the membrane substrate 11, as described above, for example with a catalyst material 7 having platinum Pt contained in the catalyst paste 9. Afterwards, the layer application—not specifically represented in FIG. 3—can be dried or pre-dried in a multi-zone furnace 15. Afterwards, the strip-shaped membrane substrate 1 which is already coated on one side can be further conveyed via the rolls 21. A second side facing away from the first side of the membrane substrate 11 of the same can now be coated with a catalyst paste 9 which contains iridium Ir as a catalyst material 7 until the membrane substrate 11 thus coated on both sides passes through the furnace 15 again, in particular in order to drive the solvent 3 or possible residues or binders out of the catalyst paste 9. Therefore, the drying step S5 is already integrated, at least partially, i.e. as a partial step, in the coating means 17 through the furnace 15. However, heat post-processing steps can follow.

Apart from the choice of the fluorine-free hydrocarbon as an ionomer, a choice of the solvent adapted thereto during the production process of the catalyst paste 9 has proven to be particularly advantageous for the formation of a porous surface structure with good catalytic properties and a particularly high service life of a fluorine-free catalyst-coated membrane 23 and binding to the membrane substrate 11. Contrary to the previous practice, water-free solvents 3, in the paste formulation to form a colloidal dispersion, have surprisingly proven to be very appropriate for the dissolution of the boundary surfaces, formation of an interlayer and the long-term stable binding, such as, for example, the application of the solvents N-methyl-2-pyrrolidone or 2-pyrrolidone (γ-butyrolactam).

A media dosing during wide slot nozzle application of the catalyst paste 9 can be via so-called eccentric screw pumps, for example. The coating means 17 has an unwinding reel with a brake, a strip tension (e.g. 50 Nm), a slot nozzle coater on both sides with a passage width of about 10 cm and a layout for a substrate thickness of about up to 90 μm. Upon application, a band speed between 0.8 and 1.2 m/min and an application thickness (wet film) of less than 50 μm are set. A viscosity range of 200 to 1000 mPas of the catalyst paste 9, for example, is appropriate, wherein a “wet loading” of the membrane substrate 11 of about 30 mg/cm2 and with drying in a circulating air dryer (drying temperature 80 to 100° C., for example) is performed. In general, a high solids content in weight percent (wt %) of the processable fluorine-free catalyst paste 9 of 35 to 65 wt %, in particular 45 to 55 wt %, is provided. The coating via wide slot nozzles 19 advantageously offers the possibility to control the sought wet film layer thickness of the application through the measured mass current and a predetermined substrate speed.

The designs shown in FIG. 3 and FIG. 4 of a coating means 17 on the basis of a roll-to-roll conveying technique advantageously allow a simultaneous double-sided dosing and application of two different and correspondingly specifically adapted catalyst materials 7 in a catalyst paste 9 on a provided band-shaped fluorine-free hydrocarbon-based membrane substrate 11.

In FIG. 4, an alternative design of a double-sided direct coating of a membrane substrate 11 is represented. Here, the coating means 17 is equipped with application or dosing rolls 13 via which the coating can be brought about advantageously in a simple and self-dosing manner. Otherwise, the process can be substantially analogously to the description of FIG. 3. This type of coating—also referred to as reverse roll coating—is in particular suitable for the production of a particularly evenly coated catalyst-coated membrane 23, i.e. of CCMs with a particularly high quality. Here, a double chamber furnace 15 with spatial dimensions of clearly over 1 m can also be used for a drying step S5, as well as corresponding circulating air or floating dryers in order to implement the application as evenly as possible and extensively on the fluorine-free membrane substrate 11. The drying step S5 can comprise further sub-steps, such as a multi-step heat post-processing, the so-called “curing”, which is not explained in more detail here.

An alternative application method to the coating shown in FIG. 3 and FIG. 4 of a membrane substrate 11 is represented in FIG. 5. Here, the application of the catalyst paste 9 according to step S4 in the coating means 17 outlined in FIG. 5 is only made on one side of the membrane substrate 11. As required, the side facing away from this one side can be coated with the help of a transfer printing method. In particular, the catalyst paste 9 is directly applied to a polyimide film first—not explicitly characterized here—and then laminated by way of the transfer printing. More precisely, a catalyst layer of the catalyst paste 9 can be in particular applied to an FEP-coated hydrophobized Kapton film (type Dupont 300 FN 929) by means of application rolls. The coating is then preferably in segmented fields. The generated so-called “decal films” can furthermore be laminated to the backside of the directly coated membrane by means of hot pressing methods. Due to the hydrophobization of the Kapton film, improved separating properties of the “decal” are achieved, whereby even strongly adherent plastisol layers can also be transferred.

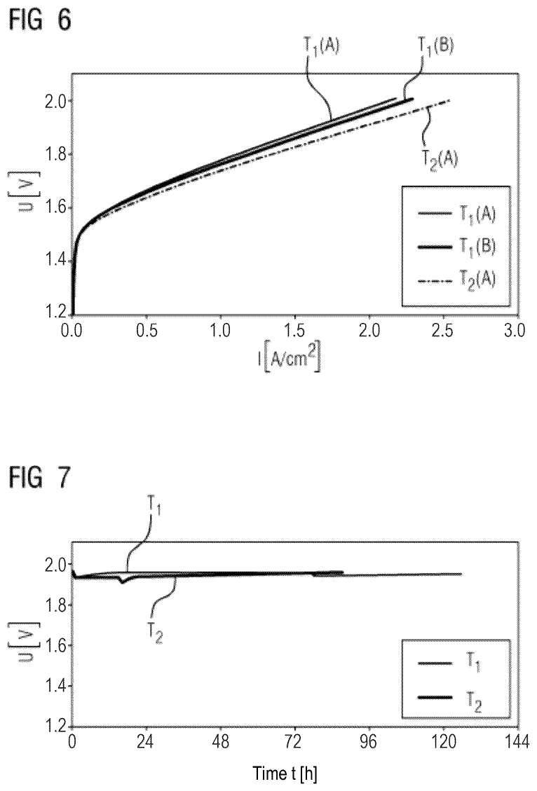

FIG. 6 also implies the result of an electrochemical characterization of the fluorine-free catalyst-coated membrane (23) directly coated according to the invention. Electrochemical characterizations were performed on the fluorine-free CCMs of the TS00X and Pemion™ test series in order to validate system efficiency (polarization curves and impedance spectroscopy), long-term stability and system security (gas chromatography). In order to electrochemically characterize the fluorine-free CCMs, U-I characteristic curves were measured. The prepared MEA samples included different electrode combinations in order to separate the influence factors on the anode and the cathode on the characteristics from one another. Specifically, a corresponding polarization curve—a U-I characteristic curve—with a cell voltage U, plotted via the respective current density I, is shown as an example in FIG. 6, wherein a proof of function is delivered in the present case. In FIG. 6, two characteristic curves T1(A) and T1(B) show results for a test series with the TS00X ionomer as a fluorine-free hydrocarbon as an example. The results of a test series with Pemion™ ionomer are represented for comparison in the characteristic curve T2(A).

Corresponding endurance tests at a constant current density of 2 A/cm2 were performed in order to obtain conclusions on the long-term stability of the samples. A known degradation effect with endurance tests is the voltage increase at a constant current density, which can be attributed to different degradation causes such as catalyst passivation, contact loss of the components, ionomer degradation, for example. As an example, FIG. 7 reflects an investigation of the long-term stability of a fluorine-free catalyst-coated membrane 23, wherein T1 shows the long-term behavior of a CCM with a TS00X ionomer and T2 shows the long-term behavior of a CCM with a Pemion™ ionomer. Here, the respective course of the cell voltage U is plotted against time t. A largely and nearly constant voltage level could be detected for both fluorine-free CCMs for a large investigation period of at least 72 h. The economic potential for the future use of fluorine-free catalyst-coated membranes 23 which are produced with the method of the invention is shown.

FIG. 8 shows a CCM 23 in a simplified representation. Through the chosen paste composition and the application method, a dissolution process is purposefully initiated, which, due to the choice of solvent and the material adaption of the ionomer, leads to the formation of an intermediate layer 33 as an important functional layer in the production process. This intermediate layer 33 provides for a good adhesion and long-term stable binding of the catalyst layer 31 having the catalyst material 7 and the fluorine-free polymer 1 on the membrane substrate 11. The catalyst layer 31 has the fluorine-free polymer 1, for example a sulfonated polyether ketone sPEEK. Also, the membrane substrate 11 has a similar or equal fluorine-free polymer 1, preferably also a sulfonated polyether ketone sPEEK. The intermediate layer 33 has a layer thickness D of about 3-10 μm so that a fixed and long-term stable material connection between the catalyst layer 31 and the membrane substrate 11 is formed via dissolution of the ionomer of a similar type.

The catalyst layer 31 provides an electrode on the membrane substrate 11, an anode electrode with platinum Pt as the catalyst material 7 in the enlargement of FIG. 8. Analogously, a cathode electrode which has iridium as the catalyst material 7 is formed on the opposite side of the membrane substrate 11. The microstructure of the electrode is a three-dimensional network of the ionomer, i.e. the fluorine-free hydrocarbon, the catalyst material 7 and pores. Due to the porous structure, the electrode is permeable for the transport of the educts and the electrolyte products. The intersection of the three components is called triple phase boundary (TPB). Here, the electrochemical reaction takes place viewed locally and microscopically, since apart from the availability of the catalyst material 7, the provision of the educts, i.e. water H2O, is also decisive for the reaction. Thus, a gas diffusion electrode or gas diffusion layer is formed on the CCM 23. In the case of platinum Pt as the catalyst material 7, the platinum catalyst can be present supported on carbon. The carbon forms agglomerates which are partly enclosed by the ionomer. It can further be distinguished between primary and secondary pores. Primary pores are located within an agglomerate and secondary pores between agglomerates. They also differ in that the ionomer is mainly present in the secondary pores and thus an increased ionic resistance is created in the primary pores.

The present invention enables the production of fluorine-free catalyst-coated membranes for PEM water electrolysis at an industrial scale. Thus, a Europe-wide threatened PFSA ban is tackled. Further, the targeted use of fluorine-free ionomers and the here proposed production of fluorine-free membrane electrode assemblies (MEAs) for PEM water electrolysis and electrolyte plants become possible. Good system efficiency and long-term stability of the fluorine-free MEAs is achieved through the advantageous paste formulation and the choice of materials.

Fluorine-free MEAs offer a range of advantages compared to fluorine-containing ionomers. First, technical advantages such as higher operating temperatures due to the higher thermal consistency of hydrocarbons for PEM water electrolysis are to be mentioned. Furthermore, an alternative technology is proposed in case an EU ban on PFAS materials is announced, which is generally expected. Thus, the method of the invention and the CCMs produced according to the method guarantee that no environmentally harmful fluorine compounds are to be treated, which can get into the environment along the process chain. Finally, a downstream recycling process is also significantly simplified since no creation of hydrogen fluoride is to be feared in a thermal reprocessing in a combustion process of the MEA. Thus, a previously required very complex gas washing of the combustion products is eliminated. Also, fewer corrosion problems induced by fluorine ions are expected during operation of an electrolyte plant which lead to disadvantageous degradation.

Furthermore, the ionomer/catalyst content can be set particularly precisely and adapted to the respective water-free solvent via the formula of the catalyst paste 9. Also, known or standardized manufacturing dimensions can be scaled up in a simple manner, for example in order to also significantly increase the production capacities of highly pure hydrogen.

1. A method for producing a catalyst-coated membrane for an electrochemical cell, comprising the following steps:
providing a powdery sulfonated fluorine-free polymer,
dispersing the sulfonated fluorine-free polymer in a water-free solvent to form a plastisol,
mixing a catalyst material with the plastisol to form a catalyst paste, and
applying the catalyst paste to a membrane substrate.

2. The method according to claim 1, wherein the water-free solvent, in particular a polar, high boiling solvent, is selected from: dimethyl sulfoxide, N,N-dimethylformamide, N,N-diethylformamide, 2-pyrrolidone or γ-butyrolactam, N-methyl-2-pyrrolidone, N-ethyl-2-pyrrolidone.

3. The method according to claim 1, wherein a mixture of N-methyl-2-pyrrolidone and a percentage selected from N-ethyl-2-pyrrolidone, γ-butyrolactone or diethylene glycol monoethyl ether is used as the water-free solvent.

4. The method according to claim 1, wherein the catalyst material comprises iridium, in particular solid or powdery Iridium Black.

5. The method according to claim 1, wherein the catalyst material comprises platinum (Pt), in particular solid or powdery Platinum Black.

6. The method according to claim 1, wherein the material of the membrane substrate is composed of a fluorine-free sulfonated polymer, wherein the sulfonated fluorine-free polymer of the catalyst paste is adapted thereto.

7. The method according to claim 1, wherein sulfonated fluorine-free polymer is provided by a fluorine-free hydrocarbon compound, in particular an aromatic hydrocarbon compound having a cation-conducting group.

8. The method according to claim 7, wherein a polyaromatic ionomer having a sulfonated side group as a cation-conducting group is provided as a sulfonated fluorine-free polymer.

9. The method according to claim 8, wherein the polyaromatic ionomer is selected from the group of sulfonated polyether ketones (sPEEK), sulfonated polyphenylenes (sPPX) and sulfonated polyimides (sPI).

10. The method according to claim 1, wherein the catalyst paste is intimately mixed to form a paste mixture, wherein a high solids content of the catalyst material and sulfonated fluorine-free polymer of 35 wt % to 60 wt %, in particular of 45 wt % to 55 wt %, is set in the paste mixture.

11. The method according to claim 1, wherein a direct application (S4) of the catalyst paste to the membrane substrate is performed by means of a blade application and optionally with help of a vacuum plate which is adapted to hold the membrane substrate.

12. The method according to claim 1, wherein direct application of the catalyst paste to the membrane substrate is performed by means of a roll-to-roll application method, in particular by using a furnace for a heat treatment during paste application for driving out the solvent.

13. The method according to claim 12, wherein applying the catalyst paste to the membrane substrate furthermore is via slot nozzle coating.

14. The method according to claim 12, wherein applying the catalyst paste to the membrane substrate is via an application roll.

15. The method according to claim 1, wherein applying the catalyst paste to the membrane substrate is double-sided, in particular with different catalyst materials on the opposite sides of the membrane substrate.

16. The method according to claim 1, wherein, after applying the catalyst paste to the membrane substrate, a drying step is performed, in which drying, curing and a thermal post-processing of the catalyst material on the catalyst-coated membrane substrate is caused.

17. The method according to claim 16, wherein an ionomer content of 6 wt % to 15 wt %, in particular of 9 wt % to 12.5 wt % is set on an anode side and/or cathode side in a layer applied to the membrane substrate and having the catalyst material.

18. A PEM membrane arrangement with a catalyst-coated membrane, which is produced according to the method according to claim 1.

19. An electrolyte cell, comprising a PEM membrane arrangement according to claim 18.

20. A cell stack, comprising a plurality of electrolyte cells according to claim 19.

21. An electrolyte plant with a cell stack according to claim 19.
